(19) United States
(12) Patent Application Publication
(10) Pub. No.: US 2010/0234269 A1
(43) Pub. Date: Sep. 16, 2010

(54) Environmentally Acceptable Hard Surface Treatment Compositions

(75) Inventors: Lisa Dreilinger, Montvale, NJ (US); Angelina Lorraine Kulbick, Montvale, NJ (US)

Correspondence Address: PARFOMAK, ANDREW N.;NORRIS MCLAUGHLIN & MARCUS PA, 875 THIRD AVE, 8TH FLOOR, NEW YORK, NY, 10022, US

(73) Assignee: Reckitt Benckiser Inc., Parsippany, NJ (US)

(21) Appl. No.: 12/672,718

(22) PCT Filed: Aug. 7, 2008
(86) PCT No.: PCT/GB08/02687

§ 371 Date: Mar. 16, 2010

Related U.S. Application Data
(60) Provisional application No. 60/956,479, filed on Aug. 17, 2007.
(60) Provisional application No. 60/973,247, filed on Sep. 18, 2007.

(51) Int. Cl. C11D 1/66; C11D 3/37; C11D 1/83

(52) U.S. Cl. 510/405

(57) ABSTRACT

An environmentally acceptable ready-to-use, alkaline hard surface cleaning composition comprising (preferably consisting essentially of):
a detersive surfactant based on glucoside surfactants;
an alkalinity constituent;
optionally but in certain embodiments necessarily a detersive anionic surfactant, preferably of the sulfate and/or sulfonate type;
water in an amount of at least 75% wt., preferably at least about 80% wt., and optionally one or more further optional constituents, including a polyacrylate polymer, fragrances, colorants, etc. with the proviso that the compositions exclude one or more of: (a) organic acids, (b) inorganic acids, (c) organic solvents selected from glycols, glycol ethers, ether acetates, and alcohols, (d) thickeners, and (e) chelating agents based on nitrogen containing organic compounds which include a plurality of carboxylic acid groups preferably wherein the compositions of the invention expressly exclude two or more, preferably three or more and yet more preferably exclude four or five of (a), (b), (c), (d) and (e).

The present invention relates to ready-to-use hard surface cleaning compositions which are particularly adapted for the cleaning treatment of hard surfaces.

Although the art is replete with hard surface cleaning compositions which are effective in the cleaning of a variety of stains which are frequently encountered on such hard surfaces, e.g., kitchen surfaces, soap scum stains and organic soils, the effective cleaning of such hard surfaces requires that in addition to water, a significant amount of chemical constituents need be necessarily present in order to effectively treat the varied stains encountered on such hard surfaces.

To date the most effective cleaning compositions for the treatment of hard s surfaces typically required one or more chemicals which, while effective in treating such hard surfaces are however typically viewed as being environmentally undesirable as featuring one or more of the following characteristics: (i) is considered as being environmentally undesirable as the chemical is a volatile organic compound (“VOC”); (ii) is considered as being environmentally undesirable as the chemical does not degrade or decompose following use when flushed down sewers, drains, septic tanks or into sewage treatment facilities; (iii) is considered as being environmentally undesirable as the chemical poses an unacceptable degree of risk to aquatic life, both plant and/or animal aquatic life. Current and future environmental concerns have spurred legislation or regulations of various countries, regions or other governmental authorities to curtail or deny the use of certain such chemicals, which has reduced the degree of selection of useful chemical raw materials to a chemical formulator. However in spite of such concerns, legislation or regulations there remains a real an continuing need to meet or exceed consumer expectations in providing technically effective hard surface cleaning compositions useful in cleaning, and optionally a disinfecting or sanitizing benefit to hard surfaces and at the same time such formulations need to be considered environmentally acceptable.

It is to this and further needs that the present invention is directed.

According to a first aspect of the invention there is provided an environmentally acceptable ready-to-use, alkaline hard surface cleaning composition comprising (preferably consisting essentially of):
a detersive surfactant based on glucoside surfactants;
an alkalinity constituent;
water in an amount of at least 75% wt., preferably at least about 80% wt., and optionally one or more further optional constituents, including a polyacrylate polymer, fragrances, colorants, etc. with the proviso that the compositions exclude one or more of: (a) organic acids, (b) inorganic acids, (c) organic solvents selected from glycols, glycol ethers, ether acetates, and alcohols, (d) thickeners, and (e) chelating agents based on nitrogen containing organic compounds which include a plurality of carboxylic acid groups. In particularly preferred embodiments the compositions of the invention expressly exclude two or more, preferably three or more and yet more preferably exclude four or five of (a), (b), (c), (d) and (e) denoted immediately above.

According to a second aspect of the invention there is provided an environmentally acceptable ready-to-use, alkaline hard surface cleaning composition comprising (preferably consisting essentially of):
a detersive anionic surfactant, preferably of the sulfate and/or sulfonate type;
a detersive surfactant based on glucoside surfactants;
an alkalinity constituent, preferably based on one or more inorganic compounds;
water in an amount of at least 70% wt., preferably at least about 80% wt., and optionally one or more further optional constituents, including a polyacrylate polymer (ACCUSOL® 445N), fragrances, colorants, etc. with the proviso that the compositions exclude one or more of: (a) organic acids, (b) inorganic acids, (c) organic solvents selected from glycols, glycol ethers, ether acetates, and alcohols, (d) thickeners, and (e) chelating agents based on nitrogen containing organic compounds which include a plurality of carboxylic acid groups. In particularly preferred embodiments the compositions of the invention expressly exclude two or more, preferably three or more and most preferably exclude four or five of (a), (b), (c), (d) and (e) denoted immediately above.

According to a further aspect of the invention there is provided a composition according to any preceding aspect which composition includes an organic solvent constituent.

According to a still further aspect of the invention there is provided a method for the manufacture of an environmentally acceptable ready-to-use hard surface cleaning composition as described herein, which is useful in providing a cleaning benefit to hard surfaces.

According to a yet further aspect of the invention there is provided as a packaged ready-to-use product, a package containing an environmentally acceptable hard surface cleaning composition as described herein which is useful in cleaning benefit to hard surfaces as are described in this patent specification.

These and other aspect or objects of the invention are disclosed in the following specification.

In all aspects, the compositions of the invention necessarily include one or more surfactants based on glucosides. Such surfactants include those based on alkylmonoglyocosides and alkylpolyglucosides and include known nonionic surfactants which are alkaline and electrolyte stable. Alkylmonoglucosides and alkylpolyglucosides are prepared generally by reacting a monosaccharide, or a compound hydrolyzable to a monosaccharide with an alcohol such as a fatty alcohol in an acid medium. Various glucoside and polyglucoside compounds including alkoxylated glucosides and processes for making them are disclosed in U.S. Pat. Nos. 2,974,134; 3,219,656; 3,598,865; 3,640,998; 3,707,535, 3,772,269; 3,839,318; 3,974,138; 4,223,129 and 4,528,106 the contents of which are incorporated by reference.

One exemplary group of such useful alkylpolyglucosides include those according to the formula:

R₂O—(CₙH₂ₙO)ᵣ—(Z)ₓ

wherein:
R₂ is a hydrophobic group selected from alkyl groups, alkylphenyl groups, hydroxyalkylphenyl groups as well as mixtures thereof, wherein the alkyl groups may be straight chained or branched, and which contain from about 8 to about 18 carbon atoms, n has a value of 2-8, especially a value of 2 or 3;
r is an integer from 0 to 10, but is preferably 0,
Z is derived from glucose; and,
x is a value from about 1 to 8, preferably from about 1.5 to 5. Preferably the alkylpolyglucosides are nonionic fatty alkylpolyglucosides which contain a straight chain or branched chain C₈-C₁₅ alkyl group, and have an average of from about 1 to 5 glucose units per fatty alkylpolyglucoside molecule. More preferably, the nonionic fatty alkylpolyglucosides which contain straight chain or branched C₈-C₁₅ alkyl group, and have an average of from about 1 to about 2 glucose units per fatty alkylpolyglucoside molecule.

A further exemplary group of alkyl glucoside surfactants suitable for use in the practice of this invention may be presented by the following formula (A):

RO—(R₁O)_{y}-(G)ₓ-Z_{b} (A)

wherein:
R is a monovalent organic radical containing from about 6 to about 30, preferably from about 8 to 18 carbon atoms,
R₁ is a divalent hydrocarbon radical containing from about 2 to about 4 carbon atoms,
y is a number which has an average value from about 0 to about 1 and is preferably 0,
G is a moiety derived from a reducing saccharide containing 5 or 6 carbon atoms; and,
x is a number having an average value from about 1 to 5 (preferably from 1.1 to 2);

### Z is O₂M¹,

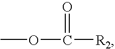

### O(CH₂), CO₂M¹, OSO₃M¹, or O(CH₂)SO₃M¹;

R₂ is (CH₂)CO₂ M¹ or CH═CHCO₂M¹; (with the proviso that Z can be O₂M¹ only if Z is in place of a primary hydroxyl group in which the primary hydroxyl-bearing carbon atom, —CH₂OH, is oxidized to form a

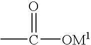

group)
b is a number of from 0 to 3x+1 preferably an average of from 0.5 to 2 per glycosal group;
p is 1 to 10,
M¹ is H⁺ or an organic or inorganic counterion, particularly cations such as, for example, an alkali metal cation, ammonium cation, monoethanolamine cation or calcium cation. As defined in Formula (A) above, R is generally the residue of a fatty alcohol having from about 8 to 30 and preferably 8 to 18 carbon atoms. Examples of such alkylglucosides as described above include, for example APG 325 CS Glucoside® which is described as being a 50% C₉-C₁₁ alkyl polyglucoside, also commonly referred to as D-glucopyranoside, (commercially available from Henkel KGaA) and Glucopon® 625 CS which is described as being a 50% C₁₀-C₁₆ alkyl polyglucoside, also commonly referred to as a D-glucopyranoside, (ex. Henkel).

Particularly preferred surfactants based on glucosides include those according to the following structure:

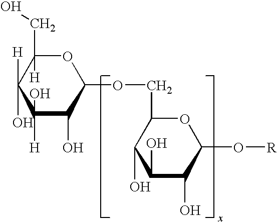

wherein:

R is an alkyl group, preferably a linear alkyl chain, which comprises C₈ to C₁₆ alkyl groups;

x is an integer value of from 0-3, inclusive.

Examples of such alkylpolyglucoside compounds according to the aforesaid structure include: where R is comprised substantially of C₈ and C₁₀ alkyl chains yielding an average value of about 9.1 alkyl groups per molecule (GLUCOPON 220 UP, GLUCOPON 225 DK); where R is comprised of C₈, C₁₀, C₁₂, C₁₄ and C₁₆ alkyl chains yielding an average value of about 10.3 alkyl groups per molecule (GLUCOPON 425N); where R is comprised substantially of C₁₂, C₁₄ and C₁₆ alkyl chains yielding an average value of about 12.8 alkyl groups per molecule (GLUCOPON 600 UP, GLUCOPON 625 CSUP, and GLUCOPON 625 FE, all of which are available from Cognis). Also useful as the alkylpolyglucoside compound is TRITON CG-110 (Union Carbide Corp. subsidiary of Dow Chemical). Further examples of commercially available alkylglucosides as described above include, for example, GLUCOPON 325N which is described as being a 50% C₉-C₁₁ alkyl polyglucoside, also commonly referred to as D-glucopyranoside (from Cognis). Particularly preferred as the surfactants based on glucosidescompounds are those illustrated in the Examples.

The surfactants based on glucosides are advantageously present in an amount of from about 0.001-8% wt., more preferably from 0.01-5% wt., and yet more preferably 0.01-3% wt. based on the total weight of the compositions of which they form a part. Particularly preferred amounts of, and identity of the surfactants based on glucosides are described with reference to one or more of the Examples.

According to certain aspects of the invention, the ready-to-use compositions necessarily include at least detersive anionic surfactant, preferably one or more anionic surfactants of the sulfate and/or sulfonate type, and especially preferably is at least one anionic surfactant of the sulfate type with an anionic surfactant of the sulfonate type. Examples of anionic surfactants include alcohol sulfates and sulfonates, alcohol phosphates and phosphonates, alkyl ester sulfates, alkyl diphenyl ether sulfonates, alkyl sulfates, alkyl ether sulfates, sulfate esters of an alkylphenoxy polyoxyethylene ethanol, alkyl monoglyceride sulfates, alkyl sulfonates, alkyl ether sulfates, alpha-olefin sulfonates, beta-alkoxy alkane sulfonates, alkyl ether sulfonates, ethoxylated alkyl sulfonates, alkylaryl sulfonates, alkylaryl sulfates, alkyl monoglyceride sulfonates, alkyl carboxylates, alkyl ether carboxylates, alkyl alkoxy carboxylates having 1 to 5 moles of ethylene oxide, alkylpolyglycolethersulfates (containing up to 10 moles of ethylene oxide), sulfosuccinates, octoxynol or nonoxynol phosphates, taurates, fatty taurides, fatty acid amide polyoxyethylene sulfates, acyl glycerol sulfonates, fatty oleyl glycerol sulfates, alkyl phenol ethylene oxide ether sulfates, paraffin sulfonates, alkyl phosphates, isethionates, N-acyl taurates, alkyl succinamates and sulfosuccinates, alkylpolysaccharide sulfates, alkylpolyglucoside sulfates, alkyl polyethoxy carboxylates, and sarcosinates or mixtures thereof. Further examples of anionic surfactants include alkyl-diphenyl-ethersulphonates and alkyl-carboxylates.

As noted previously the anionic surfactant present in the inventive compositions is preferably one or more anionic surfactants of the sulfate and/or sulfonate type

Preferred anionic surfactants of the sulfate type include alkyl sulfates which may be represented by the following general formula:

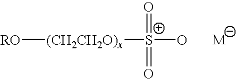

wherein R is an straight chain or branched alkyl chain having from about 8 to about 18 carbon atoms, saturated or unsaturated, and the longest linear portion of the alkyl chain is 15 carbon atoms or less on the average, M is a cation which makes the compound water soluble especially an alkali metal such as sodium, or is ammonium or substituted ammonium cation, and x is from 0 to about 4. Of these, most preferred are the non-ethoxylated C₁₂-C₁₅ primary and secondary alkyl sulfates.

Exemplary commercially available alkyl sulfates include one or more of those available under the tradenames RHODAPON® (ex. Rhone-Poulenc Co.) as well as STEPANOL® (ex. Stepan Chemical Co.). Exemplary alkyl sulfates which is preferred for use is a sodium lauryl sulfate surfactant presently commercially available as RHODAPON® LCP (ex. Rhone-Poulenc Co.), as well as a further sodium lauryl sulfate surfactant composition which is presently commercially available as STEPANOL® WAC (ex. Stepan Chemical Co.).

Preferred anionic surfactants of the sulfonate type include alkyl sulfonate anionic surfactants which may be represented according to the following general formula:

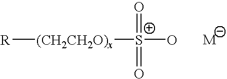

wherein R is an straight chain or branched alkyl chain having from about 8 to about 18 carbon atoms, saturated or unsaturated, and the longest linear portion of the alkyl chain is 15 carbon atoms or less on the average, M is a cation which makes the compound water soluble especially an alkali metal such as sodium, or is ammonium or substituted ammonium cation, and x is from 0 to about 4. Most preferred are the C₁₂-C₁₅ primary and secondary alkyl sulfates.

Exemplary commercially available alkane sulfonate surfactants include one or more of those available under the tradename HOSTAPUR® (ex. Clariant). An exemplary and particularly alkane sulfonate which is preferred for use is a secondary sodium alkane sulfonate surfactant presently commercially available as HOSTAPUR® SAS from Hoechst Celanese.

When present the at least detersive anionic surfactant, especially preferably when the at least one anionic surfactant is of the sulfate and/or sulfonate type may be included in amounts of from about 0.01%-10% by weight, more desirably from about 0.01%-5% by weight, and most preferably from about 0.01-1% wt. based on the total weight of the compositions of which they form a part.

In certain particularly preferred embodiments both at least one anionic surfactant of the sulfate type is concurrently present with at least one anionic surfactant of the sulfonate type as the detersive anionic surfactants of the invention, and especially preferably to the exclusion of anionic surfactants of types other than of the sulfonate type and of the sulfate type. Particularly preferred anionic surfactants and preferred amounts of such anionic surfactants are disclosed with reference to one or more of the following Examples.

As a further essential constituent, the inventive compositions necessarily also necessarily comprise an alkalinity constituent such as one or more of an alkanolamine, or an inorganic compound such as one or more alkali metal salts of various inorganic acids, such as alkali metal silicates, metasilicates, polysilicates, borates, carbonates, bicarbonates, hydroxides, and mixtures of same.

Advantageously the alkalinity constituent is an alkanolamine constituent which provides alkalinity to the compositions, as well as simultaneously providing excellent removal of hydrophobic soils which may be encountered, e.g., greases and oils. Exemplary useful alkanolamines include monoalkanolamines, dialkanolamines, trialkanolamines, and alkylalkanolamines such as alkyl-dialkanolamines, and dialkyl-monoalkanolamines. The alkanol and alkyl groups are generally short to medium chain length, that is, from 1 to 7 carbons in length. For di- and trialkanolamines and dialkyl-monoalkanolamines, these groups can be combined on the same amine to produce for example, methylethylhydroxypropylhydroxylamine. One of skill can readily ascertain other members of this group. The alkanolamine constituent may be a single alkanolamine, or may be a plurality of alkanolamines as well, and may be used in conjunction with one or more of the foregoing inorganic compounds which may also be used as an alkalinity constituent.

Desirably the alkalinity constituent is present in the hard surface cleaning compositions of the invention in amounts of from about 0.01%-10% by weight, more desirably from about 0.01%-2% by weight, and most preferably from about 0.01-1% wt. based on the total weight of the compositions of which they form a part.

Alternately the alkalinity constituent is present in a sufficient amount so to impart an alkaline pH to the compositions, preferably wherein the pH is at least 8, and yet more preferably at least 8.5. Still more preferably the pH of the ready-to-use compositions of the invention are, in order of increasing preference, at least: 8.6, 8.7, 8.8, 8.9, 9, 9.1, 9.2, 9.25, 9.3, 9.4, 9.5, 9.6, 9.7, 9.75, 9.8, 9.9, 10, 10.1, 10.2, 10.25, 10.3, 10.4, 10.5, 10.6, 10.7, 10.8, 10.9, 11, 11.1, 11.2, 11.25, 11.3, 11.4 and 11.5. Concurrently the pH of the ready-to-use compositions is not more than 13, and in order of increasing preference, not more than: 12.9, 12.8, 12.75, 12.7, 12.6, 12.5, 12.4, 12.25, 12.2, 12.1, 12, 11.9, 11.8, 11.75, 11.7, 11.6, 11.5, 11.4, 11.3, 11.25, 11.2, 11.1 and 11. In order to achieve a desired pH in this range, a sufficient amount of the alkalinity constituent may be included in the compositions.

In certain preferred embodiments, the alkalinity constituent excludes organic compounds and solely comprises one or more inorganic compounds, e.g., one or more alkali metal salts of various inorganic acids, such as alkali metal silicates, metasilicates, polysilicates, borates, carbonates, bicarbonates, hydroxides, and mixtures of same, of which the species demonstrated in one or more of the examples is particularly preferred.

In further certain preferred embodiments, the alkalinity constituent excludes inorganic compounds and solely comprises one or more organic compounds, e.g., alkanolamines such as monoalkanolamines, dialkanolamines, trialkanolamines, and alkylalkanolamines. Of such alkanolamines, the use of monoalkanolamine to the exclusion of other alkalinity constituents based on organic compounds, e.g., other alkanolamines.

As is noted above, the hard surface treatment compositions according to the invention are largely aqueous in nature. Water is added to order to provide to 100% by weight of the compositions of the invention, and desirably comprises at least 70% water, and in order of increasing preference contains 71, 72, 73, 74, 75, 76, 77, 78, 79, 80, 81, 82, 83, 84, 85, 86, 87, 88, 89, 90, 91, 92, 93, 94 and 95 percent water. Concurrently the compositions of the invention comprise, in order of increasing preference, not more than 88, 89, 90. 91. 92, 93, 94, 95, 96, 97 percent water. The water may be tap water, but is preferably distilled and is most preferably deionized water. If the water is tap water, it is preferably substantially free of any undesirable impurities such as organics or inorganics, especially minerals salts which are present in hard water which may thus undesirably interfere with the operation of the constituents present in the aqueous compositions, both concentrated and aqueous dilutions of the concentrate according to the invention.

In certain particularly preferred embodiments the compositions of the invention expressly exclude (a) organic acids, which includes organic acids which may be represented by compounds having the following formula:

R—COOH

wherein R is lower alkyl; substituted lower alkyl; hydroxy lower alkyl (e.g. HOCH₂—); carboxy lower alkyl (e.g. HOOC—CH₂—CH₂—); carboxy, hydroxy lower alkyl (e.g., HOOCCH₂CHOH—); carboxy, halo lower alkyl (e.g. HOOCCH₂CHBr—); carboxy, dihydroxy lower alkyl (e.g. HOOC—CHOH—CHOH—); dicarboxy, hydroxy lower alkyl

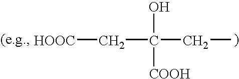

lower alkenyl, carboxy lower alkenyl (e.g. HOOCCH═CH—), dicarboxy lower alkenyl

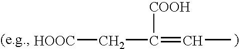

phenyl (C₆H₅—); substituted phenyl (e.g. hydroxy phenyl HO—C₆H₄—). Other acid examples include hydroxy lower alkyl e.g. lactic; carboxy, hydroxy lower alkyl, e.g. 2-methyl malic; carboxy, halo lower alkyl, e.g. 2-chloro-3-methyl succinic; carboxy, dihydroxy lower alkyl, e.g. 2-methyl tartaric; dicarboxy, hydroxy lower alkyl, e.g. 2-methyl citric acid; and carboxy lower alkenyl, e.g. fumaric. The above definitions are used in an illustrative but not a limiting sense. The term “lower” as used herein refers to an acid where “R” contains one to six carbon atoms. The term “substituted” indicates that one or more hydrogen atoms are substituted by halogen atoms (F, Cl, Br, I) hydroxyl groups, amino groups, thiol groups, nitro groups, cyano groups, etc. Examples of acids include citric, malic, succinic, lactic, glycolic, fumaric, tartaric, and formic, etc.

In certain particularly preferred embodiments the compositions of the invention expressly exclude (b) inorganic acids including: sulfuric acid, phosphoric acid, potassium dihydrogenphosphate, sodium dihydrogenphosphate, sodium sulfite, potassium sulfite, sodium pyrosulfite (sodium metabisulfite), potassium pyrosulfite (potassium metabisulfite), acid sodium hexametaphosphate, acid potassium hexametaphosphate, acid sodium pyrophosphate, acid potassium pyrophosphate, hydrochloric acid, and sulfamic acid. Other water dispersible or water soluble inorganic or mineral acids not specifically elucidated herein are also desirably excluded from certain preferred embodiments of the inventive compositions.

In certain particularly preferred embodiments the compositions of the invention expressly exclude (c) organic solvents selected from glycols, glycol ethers, ether acetates, and alcohols. Such organic solvents include C₃-C₈ alcohols which may be straight chained or branched, and which are specifically intended to include both primary and secondary alcohols. Exemplary glycol ethers include those glycol ethers having the general structure Rₐ—O—R_{b}—OH, wherein Rₐ is an alkoxy of 1 to 20 carbon atoms, or aryloxy of at least 6 carbon atoms, and R_{b} is an ether condensate of propylene glycol and/or ethylene glycol having from one to ten glycol monomer units. More specific examples of organic solvents excluded from the inventive compositions include: propylene glycol methyl ether, dipropylene glycol methyl ether, tripropylene glycol methyl ether, propylene glycol n-propyl ether, ethylene glycol n-butyl ether, diethylene glycol n-butyl ether, diethylene glycol methyl ether, propylene glycol, ethylene glycol, isopropanol, ethanol, methanol, diethylene glycol monoethyl ether acetate and particularly advantageously ethylene glycol hexyl ether, diethylene glycol hexyl ether, as well as the C₃-C₈ primary and secondary alcohols.

It is to be understood that in certain further preferred embodiments in the compositions of the invention necessarily includes one or more of the (c) organic solvents as listed above, and particularly one or more selected from glycols, glycol ethers, ether acetates, and alcohols as recited more specifically above. When present such one or more organic solvents are desirably present in amounts of up to 10% wt, preferably up to about 8% wt., and yet more preferably in amounts of up to about 5% wt, based on the total weight of the compositions of which they form a part. When present the one or more organic solvents are desirably selected from glycol ethers and alcohols, particularly preferably or more solvents selected from glycol, glycol ethers and C₁-C₄ alcohols, especially ethanol and/or isopropyl alcohol.

In certain particularly preferred embodiments the compositions of the invention expressly exclude (d) thickeners selected from the group consisting of polysaccharide polymers selected from cellulose, alkyl celluloses, alkoxy celluloses, hydroxy alkyl celluloses, alkyl hydroxy alkyl celluloses, carboxy alkyl celluloses, carboxy alkyl hydroxy alkyl celluloses, naturally occurring polysaccharide polymers such as xanthan gum, guar gum, locust bean gum, tragacanth gum, or derivatives thereof, polycarboxylate polymers, polyacrylamides, clays, for example, colloid-forming clays, e.g., smectite and/or attapulgite types of clays, and mixtures thereof.

In certain particularly preferred embodiments the compositions of the invention expressly exclude (e) chelating agents based on nitrogen containing organic compounds which include a plurality of carboxylic acid groups. Such include, e.g., ethylenediamine mono-, di- or tri-acetic acid, ethylenediaminetetraacetic acid, N-hydroxyethylethylenediamine triacetic acid, nitrilotriacetic acid, diethylene triamine pentaacetic acid, and their water soluble salts of these compounds, especially the alkali metal salts and particularly the sodium salts.

In addition to the above recited essential constituents, the alkaline, highly aqueous environmentally acceptable hard surface cleaning compositions of the invention may include one or more further optional constituents in effective amounts. Such further constituents which are usually directed to improving the aesthetic or functional features of the inventive compositions. By way of non-limiting example, such further optional constituents include: coloring agents, fragrances and fragrance solubilizers, pH adjusting agents and pH buffers including organic and inorganic salts, one or more further surfactants as co-surfactants, optical brighteners, opacifying agents, hydrotropes, preservatives, and anti-corrosion agents. When one or more of the optional constituents is added, i.e., fragrance and/or coloring agents, the esthetic and consumer appeal of the product is often favorably improved. The use and selection of these optional constituents is well known to those of ordinary skill in the art. When present, the total amount of the one or more optional constituents present in the inventive compositions do not exceed about 20% wt., preferably do not exceed 15% wt. based on the total weight of the compositions of which they form a part.

The compositions of the invention optionally but in certain cases desirably include a fragrance constituent. Such fragrances which may be natural or synthetically produced. Fragrance raw materials may be divided into three main groups: (1) the essential oils and products isolated from these oils; (2) products of animal origin; and (3) synthetic chemicals. Generally perfumes are complex mixtures or blends various organic compounds including, but not limited to, certain alcohols, aldehydes, ethers, aromatic compounds and varying amounts of essential oils such as from about 0 to about 85% by weight, usually from about 10 to about 70% by weight, the essential oils themselves being volatile odiferous compounds and also functioning to aid in the dissolution of the other components of the fragrance composition. Fragrance compositions as received from a supplier may be provided as an aqueous or organically solvated composition, and may include as a hydrotrope or emulsifier a surface-active agent, typically a surfactant, in minor amount, generally not in excess of about 1.5% wt. Such fragrance compositions are quite usually proprietary blends of many different specific fragrance compounds. However, one of ordinary skill in the art, by routine experimentation, may easily determine whether such a proprietary fragrance composition is compatible in the compositions of the present invention.

Such fragrances may be added in any conventional manner, admixing to a composition or blending with other constituents used to form a composition, in amounts which are found to be useful to enhance or impart the desired scent characteristic to the composition, and/or to cleaning compositions formed therefrom.

Further optional, but advantageously included constituents are one or more coloring agents which find use in modifying the appearance of the compositions and enhance their appearance from the perspective of a consumer or other end user. Known coloring agents, e.g., pigments and dyes including CI Direct dyes as well as FD&C approved colorants may be incorporated in the compositions in any effective amount to improve or impart to compositions a desired appearance or color. Such a coloring agent or coloring agents may be added in a conventional fashion, i.e., admixing to a composition or blending with other constituents used to form a composition. The inclusion of a coloring agent is frequently desired in that such provides improved visibility of the both the composition as well as, to a lesser extent, aqueous dilutions of the compositions and its presence on a surface being treated. Typically such one or more coloring agents are present in amounts not in excess of about 1.5% wt. yet more preferably are not present in amounts in excess of 1% wt. based on the total weight of the compositions of which they form a part.

The compositions of the invention may include one or more biodegradable chelating agents as well, which may be included in effective amounts.

The compositions may include one or more further surfactants selected from anionic, nonionic, cationic, zwitterionic and/or amphoteric surfactants as well, particularly wherein such are selected to be environmentally acceptable. Such one or more further surfactants may be included in any amount which is found to be effective in improving the cleaning efficacy of the compositions taught herein.

The compositions may also include certain polymers which may improve the surface appearance characteristics of hard surfaces treated by dilutions of the concentrated compositions taught herein, which polymers include polyacrylates such as a neutralized or partially neutralized polycarboxylic acid having a nominal molecular weight in the range of about 4000-8000, presently commercially available under the tradename Acusol® 445 N (ex. Rohm & Haas), or acrylate/maleate copolymers such as are presently commercially available under the tradename Sokalan® (ex. BASF). When included, such may be present in any effective amount. Advantageously such certain polymers may be included in amounts of from about 0.001-5% wt., preferably ain an amount of from about 0.001-3% wt. based on the total weigh of the composition of which it forms a part.

Preservatives may also be added in minor amounts in the compositions according to the invention. Preservative compositions known in the art including commercially available preparations can be used. Examples of such preservatives compounds include those which are presently commercially available under the trademarks Kathon® CG/ICP (Rohm & Haas, Philadelphia Pa.), Suttocide® A (Sutton Labs, Chatham N.J.) as well as Midtect® TFP (Tri-K Co., Emerson, N.J.). Such preservatives are generally added in only minor amounts, i.e., amounts of about 0.5% by weight of the total composition, more generally an amount of about 0.1% by weight and less, and preferably present in amounts of about 0.05% by weight and less. Typically such preservative constituents are not necessary in the inventive compositions due to their alkaline pH.

The compositions of the invention may include one or more pH adjusting agents, or compounds which may be use to adjust the pH of the compositions, or to buffer the pH of the compositions of which they form a part.

The compositions according to the invention are easily produced by any of a number of known art techniques. Conveniently, a part of the water is supplied to a suitable mixing vessel further provided with a stirrer or agitator, and while stirring, the remaining constituents are added to the mixing vessel, including any final amount of water needed to provide to 100% wt. of the inventive composition.

The compositions may be packaged in any suitable container particularly flasks or bottles, including squeeze-type bottles, as well as bottles provided with a spray apparatus (e.g. trigger spray) which is used to dispense the composition by spraying. The compositions are readily pourable and readily pumpable cleaning compositions which features the benefits described above. Accordingly the compositions are desirably provided as a ready to use product in a manually operated spray dispensing container, or may be supplied in aerosolized product wherein it is discharged from a pressurized aerosol container. Propellants which may be used are well known and conventional in the art and include, for example, a hydrocarbon, of from 1 to 10 carbon atoms, such as n-propane, n-butane, isobutane, n-pentane, isopentane, and mixtures thereof; dimethyl ether and blends thereof as well as individual or mixtures of chloro-, chlorofluoro- and/or fluorohydrocarbons- and/or hydrochlorofluorocarbons (HCFCs). Useful commercially available compositions include A-70 (Aerosol compositions with a vapor pressure of 70 psig available from companies such as Diversified and Aeropress) and Dymel® 152a (1,1-difluoroethane from DuPont). Compressed gases such as carbon dioxide, compressed air, nitrogen, and possibly dense or supercritical fluids may also be used. In such an application, the composition is dispensed by activating the release nozzle of said aerosol type container onto the area in need of treatment, and in accordance with a manner as above-described the area is treated (e.g., cleaned and/or sanitized and/or disinfected). If a propellant is used, it will generally be in an amount of from about 1% to about 50% of the aerosol formulation with preferred amounts being from about 2% to about 25%, more preferably from about 5% to about 15%. Generally speaking, the amount of a particular propellant employed should provide an internal pressure of from about 20 to about 150 psig at 70° F.

Preferably, the composition is adapted for being dispensed using a trigger spray. Alternately, preferably, the composition is adapted for being dispensed using a squeeze bottle through a nozzle.

The compositions according to the invention can also be suited for use in a consumer “spray and wipe” application as a cleaning composition. In such an application, the consumer generally applies an effective amount of the composition using the pump and within a few moments thereafter, wipes off the treated area with a cloth, towel, or sponge, usually a disposable paper towel or sponge. In certain applications, however, especially where undesirable stain deposits are heavy, the cleaning composition according to the invention may be left on the stained area until it has effectively loosened the stain deposits after which it may then be wiped off, rinsed off, or otherwise removed. For particularly heavy deposits of such undesired stains, multiple applications may also be used. Optionally, after the composition has remained on the surface for a period of time, it could be rinsed or wiped from the surface.

Whereas the compositions of the present invention are intended to be used in the types of liquid forms described, nothing in this specification shall be understood as to limit the use of the composition according to the invention with a further amount of water to form a cleaning solution there from. In such a proposed diluted cleaning solution, the greater the proportion of water added to form said cleaning dilution will, the greater may be the reduction of the rate and/or efficacy of the thus formed cleaning solution. Accordingly, longer residence times upon the stain to effect their loosening and/or the usage of greater amounts may be necessitated. Preferred dilution ratios of the concentrated hard surface cleaning composition: water of 1:1-100, preferably 1:2-100, more preferably 1:3-100, yet more preferably 1:10-100, and most preferably 1:16-85, on either a weight/weight (“w/w”) ratio or alternately on a volume/volume (“v/v”) ratio.

Conversely, nothing in the specification shall be also understood to limit the forming of a “super-concentrated” cleaning composition based upon the composition described above. Such a super-concentrated ingredient composition is essentially the same as the cleaning compositions described above except in that they include a lesser amount of water.

The composition of the present invention, whether as described herein or in diluted, a concentrate or a super concentrate form, can also be applied to a hard surface by the use of a carrier substrate. One example of a useful carrier substrate is a wet wipe. The wipe can be of a woven or non-woven nature. Fabric substrates can include non-woven or woven pouches, sponges including both closed cell and open celled sponges, including sponges formed from celluloses as well as other polymeric material, as well as in the form of abrasive or non-abrasive cleaning pads. Such fabrics are known commercially in this field and are often referred to as wipes. Such substrates can be resin bonded, hydroentangled, thermally bonded, meltblown, needlepunched, or any combination of the former. The carrier substrate useful with the present inventive compositions may also be a wipe which includes a film forming substrate such as a water soluble polymer. Such self-supporting film substrates may be sandwiched between layers of fabric substrates and heat sealed to form a useful substrate.

The compositions of the present invention are advantageously absorbed onto the carrier substrate, i.e., a wipe to form a saturated wipe. The wipe can then be sealed individually in a pouch which can then be opened when needed or a multitude of wipes can be placed in a container for use on an as needed basis. The container, when closed, sufficiently sealed to prevent evaporation of any components from the compositions. In use, a wipe is removed from the container and then wiped across an area in need of treatment; in case of difficult to treat stains the wipe may be re-wiped across the area in need of treatment, or a plurality of saturated wipes may also be used.

The compositions of the invention are advantageously used in the cleaning treatment of hard surfaces, as the hard surface cleaning composition according to the invention is desirably provided as a ready to use product which may be directly applied to a hard surface. By way of non-limiting examples, hard surfaces include surfaces composed of refractory materials such as: glazed and unglazed tile, brick, porcelain, ceramics as well as stone including marble, granite, and other stones surfaces; glass; metals; plastics e.g. polyester, vinyl; fiberglass, Formica®, Corian® and other hard surfaces known to the industry. Hard surfaces which are to be particularly denoted are lavatory fixtures such as shower stalls, bathtubs and bathing appliances (racks, curtains, shower doors, shower bars) toilets, bidets, wall and flooring surfaces especially those which include refractory materials and the like. Further hard surfaces which are to be denoted are those associated with kitchen environments and other environments associated with food preparation, including cabinets and countertop surfaces as well as walls and floor surfaces especially those which include refractory materials, plastics, Formica®, Corian® and stone.

Illustrative example compositions which were produced include those set forth below. The illustrative example composition demonstrates a particularly preferred embodiment of the invention as well as preferred weight percentages as well as preferred relative weight percentages/weight ratios with regard to the respective individual constituents present within the composition.

### EXAMPLES

Several examples of ready-to-use type hard surface cleaning compositions according to the present invention are described in the following Table 1; the components indicated on Table 1 are indicated on an “active weight” basis. Table 2 identifies the specific constituents used to form the hard surface cleaning composition. The amounts of the named constituents are indicated in % w/w based on a total weight of the compositions of which they form a part. Deionized water was added in “quantum sufficient” (“q.s.”) to the composition so to provide the balance to 100 parts by weight of each.

TABLE 1

| | Ex. 1 | Ex. 2 | Ex. 3 | Ex. 4 | Ex. 5 | Ex. 6 |
|---|---|---|---|---|---|---|
| alkyl polyglycoside | 1.7 | 2 | 2 | 2.8 | 2 | 2 |
| sodium lauryl sulfate | 0.193 | — | — | — | — | — |
| sodium lauryl ether | 0.1 | — | — | — | — | — |
| sulfate | | | | | | |
| C₉-C₁₁ alcohol | — | — | — | 1.5 | — | — |
| ethoxylate, | | | | | | |
| 6-9 mols EO | | | | | | |
| monoethanlamine | — | 0.5 | 0.5 | 0.75 | 0.5 | 0.5 |
| sodium carbonate | 0.5 | — | — | — | — | — |
| polycarboxylate | — | — | — | 0.23 | — | — |
| fragrance | 0.012 | — | — | — | — | 0.25 |
| dye | 0.003 | — | 0.0025 | 0.0035 | — | — |
| d.i. water | q.s. | q.s. | q.s. | q.s. | q.s. | q.s. |

| | Ex. 7 | Ex. 8 |
|---|---|---|
| alkyl polyglycoside | 1.25 | 0.12 |
| sodium lauryl sulfate | — | — |
| sodium lauryl ether sulfate | — | — |
| C₉-C₁₁ alcohol ethoxylate, 6-9 mols EO | — | — |
| monoethanlamine | — | 0.11 |
| propylene glycol n-butyl ether | — | 1.0 |
| propylene glycol methyl ether | — | 0.7 |
| propylene glycol | — | 0.2 |
| ethanol | — | 2.8 |
| sodium carbonate | 0.5 | — |
| polycarboxylate | — | — |
| fragrance | 0.14 | 0.013 |
| dye | 0.003 | 0.003 |
| d.i. water | q.s. | q.s. |

The composition according to Ex. 8 illustrates a composition which necessarily includes one or more organic solvents, and which exemplifies a preferred system of organic solvents.

Each of the foregoing compositions of Table 1 exhibited a pH of approximately 10.5. The identity of the specific constituents are described on the following Table 2.

TABLE 2

| | |
|---|---|
| alkyl polyglucoside | supplied by Glucopon ® 425N |
| C₉-C₁₁ alcohol ethoxylate, 6-9 | supplied by Lutensol ® XP 79 |
| mols EO | |
| sodium lauryl sulfate | supplied by Empicol LX28 |
| sodium lauryl ether sulfate | supplied by Empicil ESC3 |
| monoethanolamine | laboratory grade |
| | monoethanolamine |
| propylene glycol n-butyl ether | supplied by Dowanol ® PnB |
| propylene glycol methyl ether | supplied by Dowanol ® PM |
| sodium carbonate | laboratory grade |
| polycarboxylate polymer | supplied by Acusol ® 445N |
| fragrance | proprietary composition of its |
| | supplier |
| dye | proprietary composition of its |
| | supplier |
| d.i. water | deionized water |

### Cleaning Evaluation

Cleaning evaluations for greasy soils were performed in accordance with the testing protocol outlined according to ASTM D4488 A2 Test Method, which evaluated the efficacy of the cleaning compositions on masonite wallboard samples painted with wall paint. The soil applied was a greasy soil sample containing vegetable oil, food shortening and animal fat. The sponge (water dampened) of a Gardner Abrasion Tester apparatus was squirted with a 15 gram sample of a tested cleaning composition, and the apparatus was cycled 10 times. The evaluation of cleaning compositions was “paired” with one side of each of the test samples treated with a composition according to the invention, and the other side of the same sample treated with a comparative example's composition, thus allowing a “side-by-side” comparison to be made. Each of these tests were duplicated on at least 5 wallboard tiles and the results statistically analyzed and the averaged results reported on Table 3, below. The cleaning efficacy of the tested compositions were evaluated the cleaning efficacy of the tested compositions was evaluated utilizing a high resolution digital imaging system which evaluated the light reflectance characteristics of the each tested sample wallboard sample. This system utilized a photographic copy stand mounted within a light box housing which provided diffuse, reflected light supplied by two 15 watt, 18 inch type T8 fluorescent bulbs rated to have a color output of 4100K which approximated “natural sunlight” as noted by the manufacturer. The two fluorescent bulbs were positioned parallel to one another and placed parallel and beyond two opposite sides of the test substrate (test tile) and in a common horizontal plane parallel to the upper surface of the test substrate being evaluated, and between the upper surface of the tile and the front element of the lens of a CCD camera. The CCD camera was a “QImaging Retiga series” CCD camera, with a Schneider-Kreuznach Cinegon Compact Series lens, f1.9/10 mm, 1 inch format (Schneider-Kreuznach model #21-1001978) which CCD camera was mounted on the copy stand with the lens directed downwardly towards the board of the copy stand on which a test substrate was placed directly beneath the lens. The light box housing enclosed the photographic copy stand, the two 18 inch fluorescent bulbs and a closeable door permitted for the insertion, placement and withdrawal of a test tile which door was closed during exposure of the CCD camera to a test tile. In such a manner, extraneous light and variability of the light source during the evaluation of a series of tested substrates was minimized, also minimizing exposure and reading errors by the CCD camera.

The CCD camera was attached to a desktop computer via a Firewire IEEE 1394 interface and exposure data from the CCD camera was read by a computer program, “Media Cybernetics Image Pro Plus v. 6.0”, which was used to evaluate the exposures obtained by the CCD camera, which were subsequently analyzed in accordance with the following. The percentage of the test soil removal from each test substrate (tile) was determined utilizing the following equation:

$$\% Removal = \frac{RC - RS}{RO - RS} \times 100$$

where

RC=Reflectance of tile after cleaning with test product

RO=Reflectance of original soiled tile

RS=Reflectance of soiled tile

The cleaning performance of one or more of the Examples was compared to the cleaning performance of one or more comparative examples which are described in the following tables. In these comparative examples, the amounts of the named constituents are indicated in % w/w based on a total weight of the compositions of which they form a part. Deionized water was added in “quantum sufficient” (“q.s.”) to the hard surface cleaning composition so to provide the balance to 100 parts by weight of each.

| Comparative 1 (“C1”) | % w/w |
|---|---|
| alkyl polyglucoside (supplied by APG 425 NK) | 0.065 |
| sodium lauryl sulfate | 0.058 |
| sodium lauryl ether sulfate | 0.1 |
| monoethanolamine | 0.1 |
| propylene glycol n-butyl ether (supplied by Dowanol ® PnB) | 1 |
| propylene glycol methyl ether (supplied by Dowanol ® PM) | 0.7 |
| propylene glycol | 0.2 |
| fragrance | 0.013 |
| dye | 0.001 |
| d.i. water | |

| Comparative 2 (“C2”) | % wt. |
|---|---|
| alkyl polyglucoside (supplied by APG 325 NK) | 3.63 |
| benzalkonium chloride | 1.18 |
| C₁₂-C₁₆ linear alcohol ethoxylate, 7EO (supplied by Genapol | 3 |
| LA 070S) | |
| tetrasodium EDTA | 0.1 |
| sodium borate decahydrate | 0.09 |
| colorant | 0.004 |
| fragrance | 0.3 |
| d.i. water | q.s. |

| Comparative 3 (“C3”) | % wt. |
|---|---|
| C₉-C₁₁ ethoxylated alcohol, 6 mols EO | 1 |
| secondary sodium alkane sulfonate surfactant | 1 |
| dipropylene glycol n-butyl ether | 3 |
| lactic acid | 4 |
| sodium hydroxide | 0.27 |
| xanthan gum | 0.15 |
| colorant | 0.004 |
| fragrance | 0.3 |
| d.i. water | q.s. |

Compositions according to Ex.1 and Ex.7 described on Table 1, as well as compositions according to comparative examples C1 and C3 was tested for cleaning efficacy according to the foregoing test protocol.

The % soil removed was determined to be:

| | % soil removed |
|---|---|
| Ex. 1 | 74.12 |
| Ex. 7 | 78.33 |
| C1 | 67.83 |
| C3 | 82.61 |

The excellent cleaning efficacy of the inventive compositions are shown which were similar to or superior to the comparative compositions which comprised additional constituents which are not required of, or in certain preferred embodiments are desirably expressly excluded from compositions according to the invention. For example the inclusion of the glycol ether solvents present in C1 are demonstrated to detract from the overall cleaning efficacy of that composition, which the C2 composition included a significant proportion of an organic acid and also a glycol ether solvent, both such constituents frequently considered to be environmentally unacceptable, yet the C2 achieved only marginally improved cleaning as compared to the Ex.1 and Ex.7 compositions.

While the invention is susceptible of various modifications and alternative forms, it is to be understood that specific embodiments thereof have been shown by way of example in the drawings which are not intended to limit the invention to the particular forms disclosed; on the contrary the intention is to cover all modifications, equivalents and alternatives falling within the scope and spirit of the invention as expressed in the appended claims.

1. An alkaline hard surface cleaning composition comprising:
a detersive surfactant based on glucoside surfactants;
an alkalinity constituent;
water in an amount of at least 75% wt., and optionally one or more further optional constituents, including a polyacrylate polymer, fragrances, colorants, etc. with the proviso that the compositions exclude one or more of: (a) organic acids, (b) inorganic acids, (c) organic solvents selected from glycols, glycol ethers, ether acetates, and alcohols, (d) thickeners, and (e) chelating agents based on nitrogen containing organic compounds which include a plurality of carboxylic acid groups.

2. An alkaline hard surface cleaning composition comprising:
a detersive anionic surfactant of the sulfate and/or sulfonate type;
a detersive surfactant based on glucoside surfactants;
an alkalinity constituent based on one or more inorganic compounds;
water in an amount of at least 70% wt., and optionally one or more further optional constituents, including a polyacrylate polymer (ACCUSOL® 445N), fragrances, colorants, etc. with the proviso that the compositions exclude one or more of: (a) organic acids, (b) inorganic acids, (c) organic solvents selected from glycols, glycol ethers, ether acetates, and alcohols, (d) thickeners, and (e) chelating agents based on nitrogen containing organic compounds which include a plurality of carboxylic acid groups.

3. (canceled)

4. An alkaline hard surface cleaning composition according to claim 1 which comprises a polyacrylate polymer.

5. An alkaline hard surface cleaning composition according to claim 1 which exclude two or more of: (a) organic acids, (b) inorganic acids, (c) organic solvents selected from glycols, glycol ethers, ether acetates, and alcohols, (d) thickeners, and (e) chelating agents based on nitrogen containing organic compounds which include a plurality of carboxylic acid groups.

6. An alkaline hard surface cleaning composition according to claim 5 which exclude three or more of: (a) organic acids, (b) inorganic acids, (c) organic solvents selected from glycols, glycol ethers, ether acetates, and alcohols, (d) thickeners, and (e) chelating agents based on nitrogen containing organic compounds which include a plurality of carboxylic acid groups.

7. An alkaline hard surface cleaning composition according to claim 6 which exclude four or more of: (a) organic acids, (b) inorganic acids, (c) organic solvents selected from glycols, glycol ethers, ether acetates, and alcohols, (d) thickeners, and (e) chelating agents based on nitrogen containing organic compounds which include a plurality of carboxylic acid groups.

8. An alkaline hard surface cleaning composition according to claim 1 which excludes (c) organic solvents selected from glycols, glycol ethers, ether acetates, and alcohols.

9. An alkaline hard surface cleaning composition according to claim 2 which exclude two or more of: (a) organic acids, (b) inorganic acids, (c) organic solvents selected from glycols, glycol ethers, ether acetates, and alcohols, (d) thickeners, and (e) chelating agents based on nitrogen containing organic compounds which include a plurality of carboxylic acid groups.

10. An alkaline hard surface cleaning composition according to claim 9 which exclude three or more of: (a) organic acids, (b) inorganic acids, (c) organic solvents selected from glycols, glycol ethers, ether acetates, and alcohols, (d) thickeners, and (e) chelating agents based on nitrogen containing organic compounds which include a plurality of carboxylic acid groups.

11. An alkaline hard surface cleaning composition according to claim 10 which exclude four or more of: (a) organic acids, (b) inorganic acids, (c) organic solvents selected from glycols, glycol ethers, ether acetates, and alcohols, (d) thickeners, and (e) chelating agents based on nitrogen containing organic compounds which include a plurality of carboxylic acid groups.

12. An alkaline hard surface cleaning composition according to claim 1 which comprises one or more glycoside surfactants as the sole detersive surfactants present.

13. An alkaline hard surface cleaning composition according to claim 1 which comprises one or more glycoside surfactants with one or more anionic surfactants of the sulfate and/or sulfonate type as the sole detersive surfactants present.

14. An alkaline hard surface cleaning composition according to claim 2 which comprises one or more glycoside surfactants as the sole detersive surfactants present.

15. An alkaline hard surface cleaning composition according to claim 2 which comprises one or more glycoside surfactants with one or more anionic surfactants of the sulfate and/or sulfonate type as the sole detersive surfactants present.
